(19) United States
(12) Patent Application Publication
(10) Pub. No.: US 2026/0097325 A1
(43) Pub. Date: Apr. 9, 2026

(54) Toy Vehicle

(71) Applicant: MerchSource, LLC, Irvine, CA (US)

(72) Inventors: Ziqi Wang, Irvine, CA (US); Denny Liao, Tustin, CA (US); Crispian Tompkin, Sherman Oaks, CA (US)

(21) Appl. No.: 19/348,748

(22) Filed: Oct. 2, 2025

Related U.S. Application Data
(60) Provisional application No. 63/703,139, filed on Oct. 3, 2024.

(51) Int. Cl. A63H 17/38; A63H 29/22; B43K 8/02; B43K 29/20; B43L 1/00

(52) U.S. Cl. CPC A63H 17/38; A63H 29/22; B43K 29/20; B43L 1/00; B43K 8/02

(57) ABSTRACT

A toy vehicle is disclosed that integrates customizable surface markings, removable accessories, and functional storage for drawing instruments. The vehicle includes a main body formed of a smooth, erasable substrate configured to receive and release markings from marking instruments. The marking instruments are dual-purpose, allowing users to draw directly on designated surface regions of the vehicle and to be stowed in integrated compartments that visually mimic functional automotive elements such as headlights, taillights, and exhaust ports. The vehicle further includes removable charms and stylized figures attachable to predefined locations. Internal storage compartments retain accessories when not in use. An embedded drive assembly, power system, and remote-control interface enable electronic actuation, while integrated decorative stickers and modular mounting zones allow for extensive personalization.

### RELATED APPLICATIONS

This application claims the benefit under 35 U.S. C. § 119(e) of U.S. Provisional Patent Application Ser. No. 63/703,139, filed on Oct. 3, 2024, titled “TOY VEHICLE,” the entire contents of which are incorporated by reference herein.

### FIELD OF THE INVENTION

The present invention relates to interactive toy vehicles, and more specifically to customizable toy vehicles with erasable writing surfaces, integrated storage for drawing instruments, and removable accessories

### BACKGROUND OF THE INVENTION

Toy vehicles have long served as foundational play objects that support imagination, storytelling, and motor skill development in children. Traditionally, such vehicles have consisted of molded plastic or die-cast metal bodies, often featuring static decals, fixed body styling, and limited interactivity beyond basic rolling motion or push-and-go mechanics. While more recent innovations have introduced motorized propulsion or remote control capability, the overall creative scope offered by these toys remains largely constrained to predefined aesthetics and mechanical features.

Children, however, increasingly seek toys that provide a greater degree of personalization, narrative building, and multifunctionality. In particular, modern play preferences favor products that are expressive, customizable, and modular, allowing users to leave a mark on the toy's appearance, rearrange components, or tell a story through play patterns. Additionally, the convergence of artistic expression and constructive play has given rise to a class of toys that permit drawing or writing directly on the product itself, such as erasable boards, dolls with drawing surfaces, or building blocks with writable faces. However, such toys are typically divorced from the structural and narrative appeal of a vehicle format.

Moreover, certain art-enabled toys suffer from key limitations. First, they often fail to provide an integrated system for storing the drawing instruments, which increases the likelihood of loss or misplacement. Second, when storage for drawing instruments is present, it is frequently hidden, non-intuitive, or lacks visual continuity with the aesthetic design of the toy. Third, they rarely offer storage in a manner that contributes meaningfully to the thematic styling or functionality of the toy, thereby missing an opportunity for immersive play.

Accordingly, there exists a need for a toy vehicle that not only permits direct user customization via erasable drawing surfaces, but also provides an innovative storage system for drawing instruments, modular accessories, stylized figures, and remote controls. Such a system should visually and functionally integrate storage features with the vehicle's external and internal styling, allowing each stored element to enhance, rather than detract from, the overall play value and appearance of the vehicle. Furthermore, the toy vehicle should support a wide range of removable and interchangeable accessories that permit users to redefine the visual and thematic identity of the vehicle, enhancing storytelling, organization, and re-playability in a manner not previously achieved in the art.

### SUMMARY OF THE INVENTION

The present invention relates to a toy vehicle that enables enhanced interactivity and imaginative play through the integration of drawing instruments and visually aesthetic storage features. The invention provides a toy vehicle that not only permits user-driven customization of its surface regions using erasable drawing tools, but also offers intelligent and visually integrated storage solutions for those tools when not in use.

In one example, the invention provides a toy vehicle comprising a vehicle body having one or more surface regions and at least one drawing instrument. The vehicle body includes at least one storage compartment with a recessed geometry configured to receive at least a portion of the outer profile of the drawing instrument. The drawing instrument is removably stored within the storage compartment in a predefined orientation relative to the vehicle body. This configuration ensures intuitive organization, facilitates easy retrieval and reinsertion, and maintains a clean, unified aesthetic when the instrument is not in use.

In another example, the invention includes a toy vehicle with a holder integrated into the vehicle body. The holder is specifically positioned and configured such that the drawing instrument, when received, contributes to the outward visual appearance of a functional element of the toy vehicle. For instance, the exposed portion of the instrument may simulate a headlight, taillight, or exhaust pipe. This dual-function design elevates the play value by making the drawing instrument part of the toy vehicle's visual language.

In yet another example, the toy vehicle of the present invention comprises at least one holder and at least one drawing instrument that is removably secured within the holder. The drawing instrument is configured for repeated removal and reinsertion by the user, and the holder itself is located and shaped such that it enhances or simulates the look of a functional automotive element.

Other devices, apparatus, systems, methods, features and advantages of the invention are or will become apparent to one with skill in the art upon examination of the following figures and detailed description. It is intended that all such additional systems, methods, features and advantages be included within this description, and be within the scope of the invention, and be protected by the accompanying claims.

### BRIEF DESCRIPTION OF THE FIGURES

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a front perspective view one example of a toy vehicle of the present invention.

FIG. 2 is a rear perspective view of the toy vehicle of FIG. 1.

FIG. 3 is another rear perspective view of the toy vehicle of FIG. 1.

FIG. 4 is a rear perspective view of the toy vehicle of FIG. 1 showing various interchangeable attachments that can be removably attached to the toy vehicle.

FIG. 5 are illustrations of various interchangeable attachments that can be removably attached to the figure of the toy vehicle of FIG. 1.

FIG. 6 is a front perspective view of another example of a toy vehicle of the present invention.

FIG. 7 is a rear perspective view of the toy vehicle of FIG. 6.

FIG. 8 is an illustration of stickers that can be attached to the toy vehicle of FIG. 6.

FIG. 9 is a top view of various accessory storage compartments positioned within the toy vehicle of FIG. 6.

FIG. 10 is a top perspective view of a remote-control storage on the toy vehicle of FIG. 6.

### DESCRIPTION OF THE INVENTION

In this disclosure, all “aspects,” “examples,” “embodiments,” and “implementations” described are considered to be non-limiting and non-exclusive. Accordingly, the fact that a specific “aspect,” “example,” “embodiment,” or “implementation” is explicitly described herein does not exclude other “aspects,” “examples,” “embodiments,” and “implementations” from the scope of the present disclosure even if not explicitly described. In this disclosure, the terms “aspect,” “example,” “embodiment,” and “implementation” are used interchangeably, i.e., are considered to have interchangeable meanings.

Further, in this application, the terms “substantially,” “approximately,” or “about,” when modifying a specified numerical value, may be taken to encompass a range of values that include +/−10% of such numerical value. Further, terms such as “communicate,” and “in. communication with,” or “interfaces” or “interfaces with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate or interface with a second component is not intended to exclude the possibility that additional components may be present between, and/or operatively associated or engaged with, the first and second components.

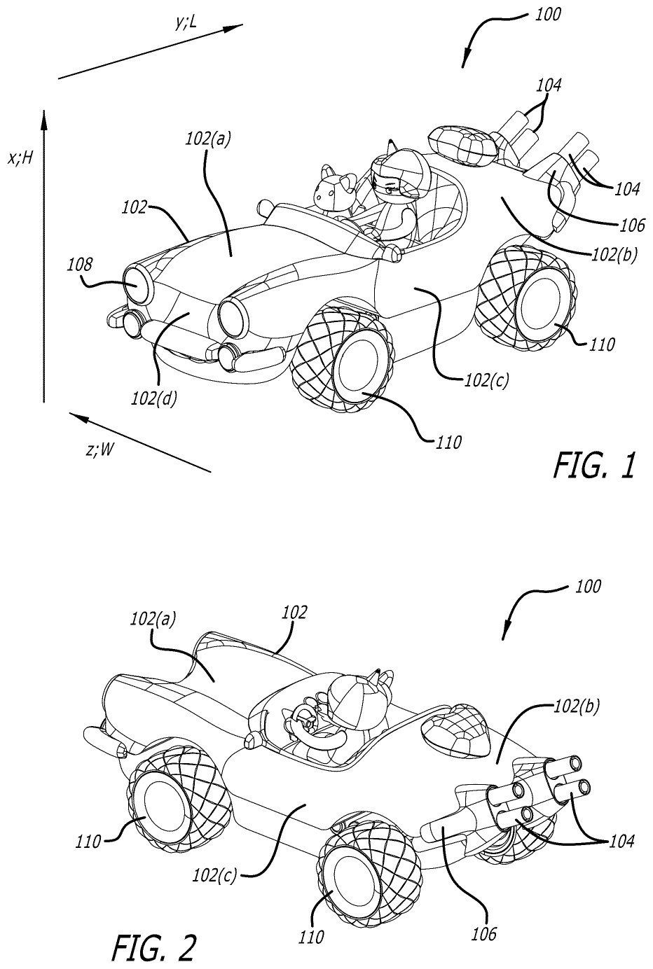

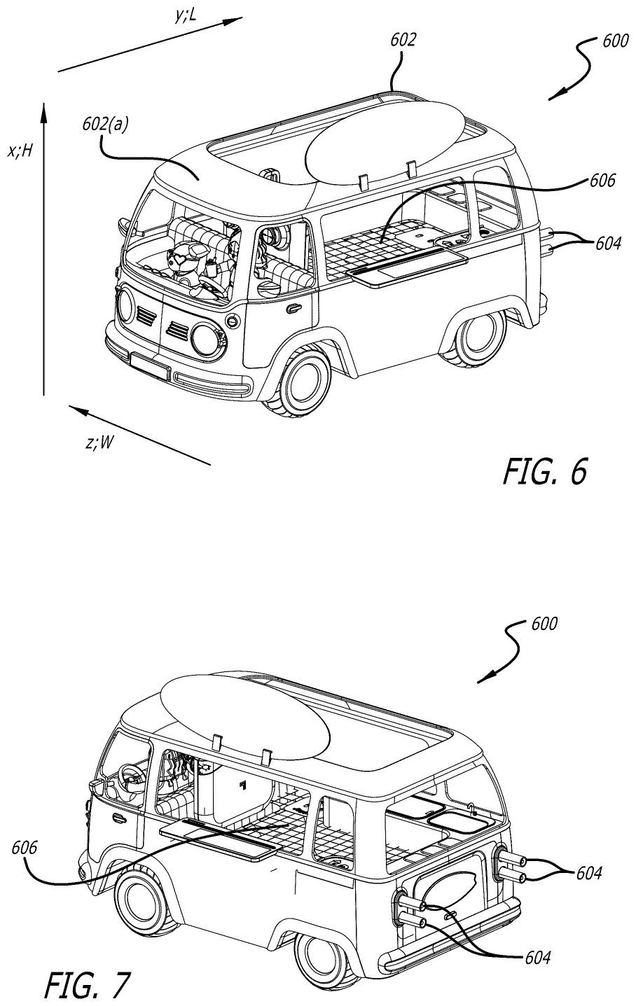

For purposes of reference and description, the toy vehicle 100, 600 of the present invention is considered to have a horizontal x-axis (x), vertical y-axis (y) and a width z-axis (z), as shown in FIGS. 1 and 6 along which the components of the toy vehicle 100, 600 are positioned relative to each other. Terms such as “axial” and “axially” are assumed to refer to the respective axis or any direction or axis parallel to the device axis, unless indicated otherwise or the context dictates otherwise. For convenience, movement relative to a device axis may alternatively encompass movement relative to an axis that is parallel to the device axis that is specifically illustrated in FIGS. 1 and 2, unless the context dictates otherwise. Thus, linear translation “along the device axis z” is not limited to translation directly on (coincident with) the device axis, but also encompasses translation parallel to the device axis z, depending on the context. Similarly, rotation “about the device axis y” also encompasses rotation about an axis that is parallel to the device axis y, depending on the context.

Further, the toy vehicle 100, 600 of the present invention is also considered to have a height (h), length (l) and width (w), as also shown most notably shown by arrows in FIGS. 1 and 6. It should be understood that the height (h), length (l) and width (w) directions also applies to all internal components of toy vehicle 100, 600.

Referring now to the figures and exemplary embodiments of the invention, a toy vehicle 100, 600 is provided which enables a high degree of user interactivity through customizable surface markings, interchangeable components, electronic actuation, and intelligent storage design.

FIGS. 1 and 2 are front and rear perspective views of one example of a toy vehicle 100 of the present invention. Toy vehicle 100 includes a main body 102 that may be formed from a high-gloss, non-porous substrate, such as acrylonitrile butadiene styrene (ABS) or polycarbonate, optionally with a clear UV-resistant coating to enhance durability and surface writability. This substrate is specifically selected and processed to provide a smooth, low-energy surface that resists permanent ink adhesion while also withstanding repeated wiping and reapplication of dry erase markings from instruments 104. The body 102 comprises multiple surface regions or zones for drawing or writing including but not limited to the hood 102(a), trunk or rear 102(b), left and right sides or side doors 102(c), front 102d, and roof 602a (shown in FIG. 6). Each zone or area is configured to receive ink, or more particularly erasable ink, from one or more drawing or writing instruments 104. The drawing instruments 104 may be markers or more particularly, dry erase markers. This arrangement allows users to personalize every major external surface region of the toy vehicle 100 with erasable designs, logos, racing stripes, or imaginative decorations, dramatically expanding the scope of play and re-playability compared to static toy vehicles.

The instruments 104 are configured for dual use: for writing/drawing and decorating the toy vehicle surface regions and for storage within aesthetic compartments that mimic functional features of the toy vehicle 100. Each instrument 104 comprises a tubular barrel 104(a) formed from plastic or composite material, a felt tip configured for fluid delivery, and a cap 104 (b) optionally colored to represent functional elements of toy vehicle 100 such as vehicle lights. In one embodiment, the cap 104(b) may be tinted red, amber, or white to further enhance the illusion of automotive lighting components, while the barrel 104(a) may include textured or reflective portions that align with adjacent body features to complete the illusion. The ink formulation within each instrument 104 comprises pigment particles suspended in a non-adhering solvent system that includes a silicone-based or polymeric release agent that prevents strong adhesion to smooth, non-porous surfaces such as the toy vehicle's surface regions.

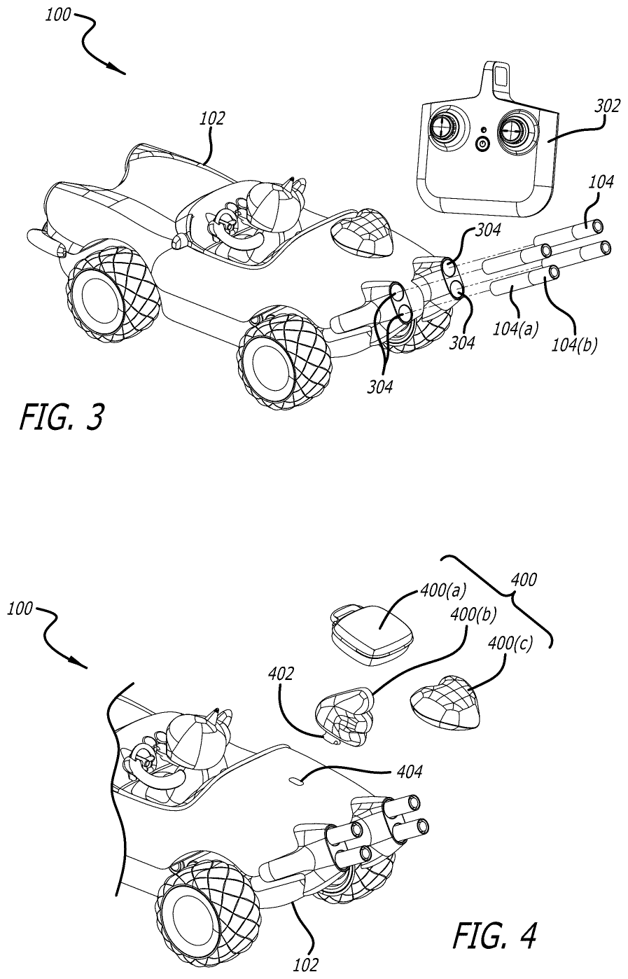

FIG. 3 is another rear perspective view of toy vehicle 100 illustrating the instruments 104 removed from storage compartments or holders 304. As shown, the storage compartments or holders 304 for instruments 104 are integrated into the vehicle main body 102. In one example, storage compartments or holders 304 are integrated into the vehicle main body 102 and are specifically contoured to receive the instruments 104 such that, when stored, the exposed instrument portions such as the cap 104(b) simulate functional vehicle components. Each storage compartment or holder 304 may have a recessed geometry configured to receive at least a portion of the outer profile of each instrument 104 such that the each instrument 104 is removably stored within the storage compartment 304 in a predefined orientation relative to the vehicle main body 102. This structural integration functionally contributes to efficient organization of the drawing instruments, reduces the likelihood of loss or misplacement during play, and enhances the thematic consistency of the toy vehicle's appearance.

As shown in FIG. 3, compartments 304 may be rear-facing and positioned on the taillight or rear exhaust 106 on the rear of the vehicle 100 and may be shaped as cylindrical open tubes or partial recesses for receiving instruments 104 horizontally or at a slight angle, such that the instruments 104, namely the caps 104(b), face outward to resemble taillights or exhaust pipes of toy vehicle 100 when stored or held in compartments 304. In other examples, compartments 304 may be front-facing and positioned on the headlights 108 on the front of vehicle 100 such that instruments 104, namely the caps 104(b), face outward and resemble headlights of toy vehicle 100 when stored or held in compartments 304. One or more storage compartments, holders or ports 304 may be located in other areas of the vehicle main body 102 to allow one or more instruments 104, when stored within one or more compartments 304, to visually mimic other functional elements of toy vehicle 100 or contribute to the outward visual appearance of a functional element of toy vehicle 100, including but not limited to one or more: headlights, taillights, exhaust ports or pipes, bumpers, roof racks, side bars and wheel hubs. One or more storage compartments, ports or holders 304 may by itself, without the storage of instruments 104, may also visually mimic functional elements of toy vehicle 100 or contribute to the outward visual appearance of a functional element of toy vehicle 100 including but not limited to one or more: headlights, taillights, exhaust ports, bumpers, roof racks, side bars and wheel hubs. This configuration ensures that even when no instruments 104 are stored, the toy vehicle 100 retains a realistic, highly detailed appearance, and when the instruments 104 are inserted or stored, the vehicle's look becomes even richer and more authentic.

Instruments 104 may be held or stored in compartments 304 in a predefined orientation relative to the vehicle main body 102. Such predefined orientation adds or contributes to the visual functional elements of toy vehicle 100. This orientation also standardizes the user experience, making it intuitive for a child to remove, use, and reinsert each instrument without disrupting the vehicle's balanced appearance or structural integrity. Instruments 104 may be secured within these compartments 304 by retention mechanisms, including but not limited to: gravity, frictional fit, spring-loaded mechanisms, or by ferro-magnetics. These retention mechanisms ensure stability of instruments 104 even during vigorous play yet permit smooth removal when the user wishes to decorate the vehicle's surface regions. The combination of predefined orientation and selective retention features thus creates a highly interactive, user-friendly system that enhances play value, preserves the vehicle's aesthetic coherence, and prevents accidental loss of the instruments 104.

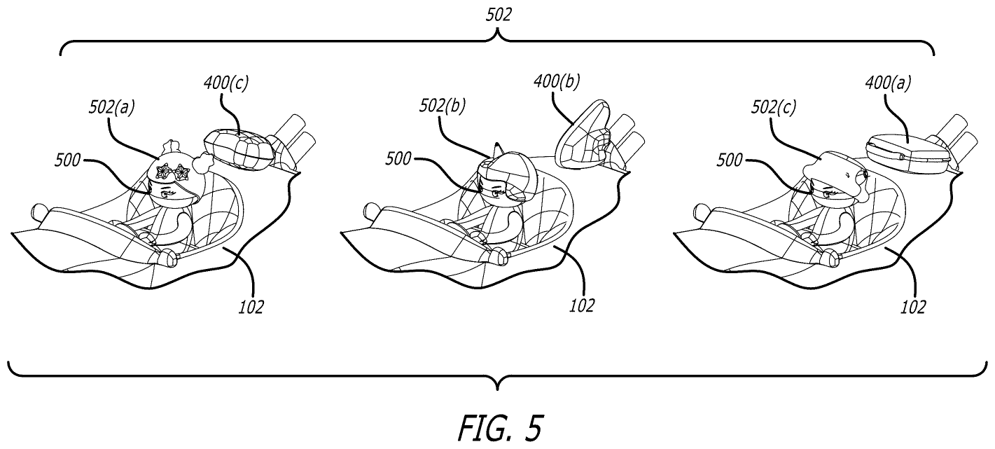

Toy vehicle 100 further supports extensive personalization through the use of removable decorative accessories and figures. In particular, FIG. 4 is a rear perspective view of toy vehicle 100 showing various interchangeable attachments 400 that can be removably attached to toy vehicle 100 and FIG. 5 are illustrations of various interchangeable figures and figure accessories that can be removably attached to toy vehicle 100.

FIG. 4 shows a plurality of accessories or charms 400, included but not limited to a suitcase 400(a), wing 400(b) and heart 400(c) that can be removably and interchangeably attached to the vehicle main body 102 via a securing mechanism that includes a peg or shaft 402 positioned on charm 400 that frictionally fits into slot or hole 404 positioned on toy vehicle 100. The shaft or peg 402 may include a circumferential retention rib or barbed contour to enhance engagement with the slot 404 and prevent accidental detachment during handling or movement of the vehicle. It should be understood that other securing mechanisms known in the art can be utilized for removably securing charms 400 to toy vehicle 100, including but not limited to friction fit, clips, screws, magnets, straps and hook and loop fasteners. Charms 400 may further be mounted to various locations on toy vehicle 100 including but not limited to hood 102(a), trunk or rear 102(b), left and right sides or side doors 102(c), front 102d, and roof 602a. This distributed mounting architecture allows for thematic placement of charms 400 that visually reinforce the personality or storyline of the toy vehicle, such as vacation themes, fantasy wings, or whimsical shapes. Charms 400 may be fabricated from rigid plastic or soft-molded elastomers and may include molded-in detailing, painted graphics, or embedded glitter or lighting effects. Lighting effects may include low-voltage LED modules powered by micro coin cells embedded within the charm body, with activation mechanisms triggered by pressure or magnetic proximity switches.

As shown in FIG. 5, toy vehicle 100 also supports one or more stylized FIG. 500 that may be removably attached to interior or exterior mounting areas of toy vehicle 100. These FIG. 500 may include humanoid, animal, or character-themed representations configured to match accessory motifs, character branding, or fantasy narratives. Similar to charms 400, FIG. 500 may be removably attached to toy vehicle 100 by any securing mechanism known in the art including but not limited to friction fit, clips, screws, magnets, straps and hook and loop fasteners. In one example, FIG. 500 may include a base connector formed as a keyed footplate, cylindrical peg, or magnetically active pad designed to couple with complementary sockets or ferromagnetic pads integrated into a seating area or platform of the toy vehicle 100. Figures may also be adorned with removable and interchangeable figure accessories 502 including wigs, hats 502(a)-(c), glasses, backpacks, handheld props, and outfits. These figure accessories 502 may interchangeably attach to FIG. 500 by any securing mechanism known in the art including but not limited to friction fit, clips, screws, magnets, straps and hook and loop fasteners. Snap-fit ball-and-socket joints may also be used for articulated accessories such as hats and backpacks, allowing angular adjustment and dynamic posing of the figures.

FIGS. 6-11 illustrate another example of a toy vehicle 600 of the present invention. It should be understood that all features and functions incorporated in toy vehicle 100 may also be incorporated in toy vehicle 600. Similarly, all features and functions incorporated in toy vehicle 600 may also be incorporated in toy vehicle 100. The disclosed vehicles are therefore part of a cross-compatible system wherein component modules, accessories, electronic subsystems, and aesthetic enhancements may be shared, interchanged, or upgraded across different toy vehicle variants.

FIGS. 6 and 7 are front and rear perspective views of toy vehicle 600. In this example, instruments 604 are removably held or stored in the storage compartments of vehicle main body 602 and when stored within the one or more compartments, visually mimics the taillights of toy vehicle 600. Each instrument 604 may be received into a recessed cavity at the rear bumper that conforms to the outer barrel geometry and is dimensioned to ensure that only a portion of instrument 604 is exposed when fully inserted, thereby completing or contributing to the taillight aesthetic. LEDs may optionally be positioned behind the instrument storage area to provide functional backlighting, further enhancing the visual realism and encouraging nighttime or dim-light play.

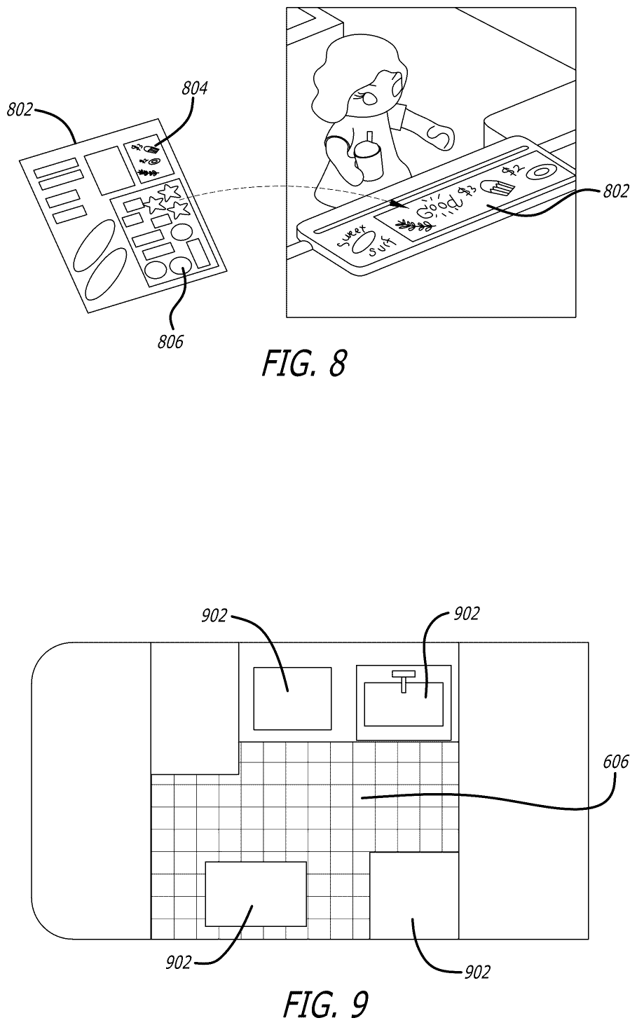

FIG. 8 is an illustration of stickers 802 that can be attached to toy vehicle 100, 600. Stickers 802 may comprise of pre-printed decals 804 and blank sticker sheets 806 configured to receive user-created artwork using the marking instruments 104, 604. Pre-printed decals may include themes such as racing insignias, flames, sponsor logos, license plates, or fantasy symbols, while blank sticker sheets may be formed of a writable polypropylene film or vinyl substrate with repositionable adhesive backing. Stickers 802 may be applied to any surface region of the toy vehicle 100, 600 including but not limited to the hood, roof, doors, trunk, wheels, and side skirts. The stickers 802 can be removed and reapplied without damaging the vehicle's surface, offering a dynamic method of customization.

FIG. 9 is a top view of various accessory storage compartments positioned within the toy vehicle 600. To support organization and component retention, toy vehicle 600 may incorporate an interior area 606 for storage compartments 902 for the interchangeable accessories, including but not limited to, charms 400, FIG. 500, figure accessories 502, and stickers 802. These accessory storage compartments 902 may be accessed via hinged panels, sliding drawers, or magnetically latched flaps that blend seamlessly with the vehicle body styling. The internal architecture of compartments 902 may include contoured recesses shaped to match the geometries of specific charms and accessories, as well as flexible retention tabs, foam inserts, or nesting trays for neatly arranging components during transport or storage.

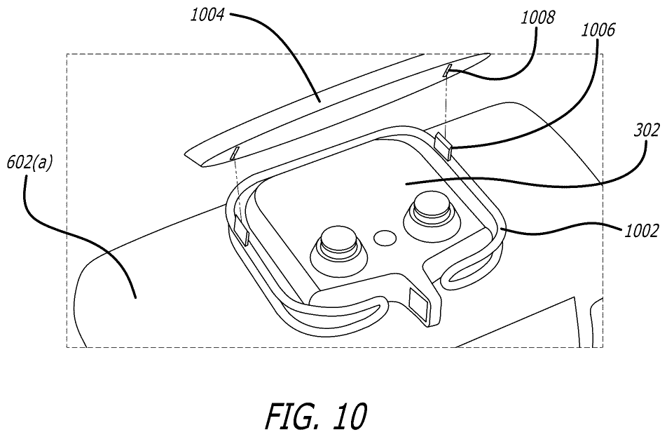

FIG. 10 is a top perspective view of a remote-control storage compartment 1002 on toy vehicle 600. Toy vehicle 100, 600 may house a drive assembly including a motor, geartrain, and drivetrain components that are operably coupled to one or more wheels 110. The motor may be controlled by remote control 302. The vehicle may include a dedicated compartment 1002 for securing and storing remote control 302. The compartment 1002 is designed to securely hold the remote control 302 when not in use, ensuring that it is easily accessible and less likely to be misplaced.

The remote control storage 1002 is integrated into the vehicle body in a manner that complements the overall design without detracting from the aesthetic or function of the vehicle. This compartment 1002 may be located on the top, bottom, front, or rear of the toy vehicle, depending on the specific model. In the present example, compartment 1002 is positioned on the roof of vehicle 600 and secured by a surfboard that also functions as a securing lid or aesthetic cover. The surfboard may include downwardly extending tabs or slots 1008 that engage with corresponding slots or tabs 1006 of the compartment 1002 to form a locking lid mechanism. Additional retention may be provided via magnetic tabs, elastomeric gaskets, or latching pegs to prevent accidental opening. The remote control 502 may be held in place via friction fit, straps, clips, or embedded magnets. In other examples, the securing mechanism for holding remote control 302 may include but is not limited to friction fit, clips, screws, magnets, straps and hook and loop fasteners. The structural integration of remote storage into the vehicle body enables a compact and self-contained product architecture that simplifies logistics, encourages tidy storage, and enhances overall user experience.

The remote controller for the vehicle disclosed herein may be one or more modules, control units, components, or the like configured for controlling, monitoring, analyzing and/or timing the operations of various devices or components of the vehicle, as well as controlling or executing one or more steps of any of the methods disclosed herein. In addition to the components of vehicle described above, the vehicle may include alternative electrical power (voltage) sources, timing controllers, fuses, clocks, processors, integrated circuits, logic circuits, memories, databases, etc. One or more modules of the controller may be, or be embodied in, one or more devices located outside or separate from the vehicle, for example, a computer workstation, desktop computer, laptop computer, portable computer, tablet computer, handheld computer, mobile computing device, personal digital assistant (PDA), smartphone, remote control, etc. One or more modules of the controller may communicate with one or more other modules via one or more busses or other types of communication lines or wireless links, as appreciated by persons skilled in the art.

In the illustrated implementation, the remote controller may include one or more electronics-based processors, which may be representative of a main electronic processor providing overall control, and one or more electronic processors configured for dedicated control operations or specific signal processing tasks (e.g., a graphics processing unit or GPU, a digital signal processor or DSP, an application-specific integrated circuit or ASIC, a field-programmable gate array or FPGA, etc.). The controller also includes one or more memories (volatile and/or non-volatile types, e.g. RAM and/or ROM) for storing data and/or software. Stored data may be organized, for example, in one or more databases or look-up tables. The controller may also include one or more device drivers for controlling one or more types of user interface devices and providing an interface between the user interface devices and components of the controller communicating with the user interface devices. Such user interface devices may include user input devices (e.g., buttons, switches, keyboard, keypad, touch screen, mouse, joystick, trackball, and the like) and user output devices (e.g., display screen, printer, visual indicators or alerts, audible indicators or alerts, and the like). In various implementations, the controller may be considered as including one or more of the user input devices and/or user output devices, or at least as communicating with them.

In some implementations, the remote controller may also include one or more types of computer programs or software contained in memory and/or on one or more types of non-transitory (or tangible) computer-readable media. One or more devices of the controller may be configured to receive and read (and optionally write to) the computer-readable media. The computer programs or software may contain non-transitory instructions (e.g., logic instructions) for controlling or performing various operations of the vehicle. The computer programs or software may include system software and application software. System software may include an operating system for controlling and managing various functions of the controller, including interaction between hardware and application software. In particular, the operating system may provide a graphical user interface (GUI) displayable via a user output device, and with which a user may interact with the use of a user input device. Application software may include software configured to control or execute various operations of the vehicle, and/or some or all of the steps of any of the methods disclosed herein.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the system controller. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), application specific integrated circuits (ASICs), field-programmable gate array (FPGAs), etc. Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the system controller), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

It will also be understood that the term “in signal communication” or “in electrical communication” as used herein means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

Further, it will be understood that terms such as “communicate” and “in. communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

What is claimed is:

1. A toy vehicle comprising:
a vehicle body having one or more surface regions;
at least one drawing instrument; and
at least one storage compartment integrated into the vehicle body, the at least one storage compartment having a recessed geometry configured to receive at least a portion of the outer profile of that least one drawing instrument such that the at least one drawing instrument is removably stored within the at least one storage compartment in a predefined orientation relative to the vehicle body.

2. The toy vehicle of claim 1, where the one or more surface regions is formed from a non-porous material for receiving dry erase markings and where the at least one drawing instrument is a dry erase marker.

3. The toy vehicle of claim 1, where the at least one drawing instrument, when stored within the at least one storage compartment, visually mimics a functional element of the toy vehicle.

4. The toy vehicle of claim 3, where the functional element is selected from the group consisting of a headlight, taillight, exhaust port, bumper, roof rack, side bar and wheel hub.

5. The toy vehicle of claim 1 further comprising at least one accessory mount on the vehicle body configured to receive a removable charm, figure, or figure accessory.

6. The toy vehicle of claim 1, further comprising a plurality of stickers configured for removable attachment to the one or more surface regions of the vehicle body.

7. A toy vehicle comprising:
a vehicle body having one or more surface regions;
at least one drawing instrument; and
at least one holder integrated into the vehicle body, the at least one holder being positioned and configured such that the at least one drawing instrument, when received in the at least one holder, contributes to the outward visual appearance of a functional element of the toy vehicle.

8. The toy vehicle of claim 7, where the one or more surface regions is formed from a non-porous material for receiving dry erase markings and where the at least one drawing instrument is a dry erase marker.

9. The toy vehicle of claim 7, where the functional element is selected from the group consisting of a headlight, taillight, exhaust port, bumper, roof rack, side bar and wheel hub.

10. The toy vehicle of claim 7, where the vehicle body includes an integrated storage compartment for a remote control device.

11. The toy vehicle of claim 7, further comprising one or more interchangeable accessories removably attached to the vehicle body.

12. The toy vehicle of claim 11, where the vehicle body includes one or more compartments configured to store the accessories.

13. The toy vehicle of claim 7, further comprising a plurality of blank stickers formed with a writable material configured for removable attachment to the vehicle body.

14. The toy vehicle of claim 7, where the at least one drawing instrument is a marker comprising a barrel, tip and cap, where only the cap is visually exposed when the marker is received in the at least one holder.

15. A toy vehicle comprising:
a vehicle body having at least one holder and at least one drawing instrument removably held in the at least one holder, where the at least one drawing instrument is configured to be removed by a user and subsequently reinserted into the at least one holder, where the at least one holder is positioned on the vehicle such that the at least one holder contributes to the outward visual appearance of a functional element of the toy vehicle.

16. The toy vehicle of claim 15, where the vehicle body has one or more surface regions formed from a non-porous material for receiving dry erase markings and where the at least one drawing instrument is a dry erase marker.

17. The toy vehicle of claim 15, where the functional element is selected from the group consisting of a headlight, taillight, exhaust port, bumper, roof rack, side bar and wheel hub.

18. The toy vehicle of claim 15, where the at least one holder resembles a taillight, headlight or exhaust pipe housing.

19. The toy vehicle of claim 15, further comprising one or more interchangeable accessories removably attached to the vehicle body.

20. The toy vehicle of claim 19, where the accessories removably attach to the vehicle body via a slot, peg, or magnet.
